(19) United States
(12) Patent Application Publication
(10) Pub. No.: US 2010/0266978 A1
(43) Pub. Date: Oct. 21, 2010

(54) Plastic capsule for the storage and delivery of flowable dental materials and applicator to contain them

(75) Inventors: Andrej Albach, Wehrheim (DE); Hans-Joachim Zumkeller, Weilrod (DE)

Correspondence Address: Hildebrand, Christa;Norris McLaughlin & Marcus PA, 875 Third Avenue, 8th Floor, New York, NY, 10022, US

(73) Assignee: HERAEUS KULZER GMBH, Hanau (DE)

(21) Appl. No.: 12/758,880

(22) Filed: Apr. 13, 2010

(30) Foreign Application Priority Data
Apr. 21, 2009 (DE) 10 2009 017 980.1

(51) Int. Cl. A61C 5/04; B29C 45/00

(52) U.S. Cl. 433/80; 264/328.2

(57) ABSTRACT

The invention relates to a plastic capsule for the storage and delivery of dental material, the capsule exhibiting a cylindrical cavity in a first capsule section and connecting the first and a third capsule section in a second capsule section and the third capsule section being a dispensing nipple angled with respect to the first capsule section characterised in that the first capsule section exhibits a reinforced longitudinal side and a longitudinal formed in a round manner and the reinforced longitudinal side is an edge on a round tube, the edge forming the reinforcement, and to similar capsules with two reinforcement edges.

### BACKGROUND OF THE INVENTION

(1) Field of the Invention

The invention relates to a plastic capsule for the storage and delivery of dental material with an angled dispensing nipple on a cylindrical channel. The outside diameter and a minimal inside diameter are determined by applicators commonly available on the market. The corresponding applicator is a retaining and pressing device resembling pliers. The invention also relates to such an applicator and the interaction of applicator and capsule and to the manufacture of the capsules.

(2) Description of Related Art

A category-appropriate capsule is formed according to DE 102 18 859 A1/B4 by a tube with a circular cross-section, a circular collar being arranged at a first end. The inside diameter tapers in a second section. If the discharge pressure is too high, the collar or a third collar section which, as discharge channel, exhibits an angle α in the region of 30 degrees to 60 degrees vis-à-vis the longitudinal axis of the first capsule section, breaks.

### BRIEF SUMMARY OF THE INVENTION

The object of the present invention is the provision of capsules which withstand a higher discharge pressure and which are as easy to inscribe as possible.

To achieve this object, the capsule is reinforced on one side, in particular formed level on the longitudinal side of the channel situated opposite the exit side. The mass and/or the cross-section surface of the capsule can be increased in this area by 20%, in particular by more than 30% and particularly preferably by more than 50%.

Solutions according to the invention are described in the independent claims. The dependent claims describe preferred embodiments.

According to the invention, a plastic capsule is provided for the storage and delivery of dental material, which plastic capsule exhibits a cylindrical cavity in a first capsule section. A second capsule section formed as an adapter adapts a third capsule section angled with respect to the first capsule section and serving as dispensing nipple to the first capsule section as regards the external and the internal shape. According to the invention, an edge-type reinforcement of the first capsule section or a flat longitudinal side based on two edges is formed.

In a preferred embodiment, a level longitudinal side runs between two edges in such a way that a round basic body is reinforced by two essentially triangular strands formed beyond the round shape.

Basically, a reinforcement in the form of an almost triangular strand is also possible such that, in this embodiment, the first capsule section has an outline which has the appearance as if a gabled roof was placed on top of the round tube. In the case of this embodiment, the cavity of the first capsule section is enclosed more by the round tube than by the two surfaces of the reinforcement arranged in a triangular manner which reinforcement, in this case, is an edge.

In the preferred embodiment with a planar surface between two edges, the reinforced area exhibits, with respect to the outside dimensions, the characteristics of a cube and encloses the cylindrical cavity by half with the non-reinforced part of the plastic capsule formed as a round tube half.

The solution according to the invention makes it possible to provide, by a one-sided reinforcement, a stabilised capsule which remains unchanged regarding the dimensioning to existing applicator pistons and caps for the dispensing nipple. The first capsule section is increased in terms of its mass, its material volume and its material-exhibiting cross-sectional surface area, by the reinforcement, in comparison with a round tube. As a result of the thin tube wall, the reinforcement has a strong effect. The reinforcement going beyond a round tube amounts to 20% or more mass or volume of the material, based on a round tube, in particular more than 30%. Reinforcements which exhibit at least 50% of the mass of a round tube on which they are based, are possible according to the invention.

It has proved useful to manufacture the capsules in one piece, to arrange the reinforcement and the dispensing nipple on opposite sides or to form the first capsule section with a collar.

As a result of the reinforcement, the capsule is able to withstand much higher discharge pressures of >1000 N. In addition, the flat surface provides suitable space for applying information such as the product name, batch name and the use-by date. The embodiment with a rectangular collar leads to an unambiguous alignment in the applicator. The edges or straight surfaces permit alignment of the capsule during automated manufacture. In the following, the invention is described in further detail with reference to the attached drawings.

The formation of the capsule with a flat side allows a simple, easily legible four-line inscription to be applied. The flat surface can be inscribed highly efficiently using a laser. A rough inscription of the round parts can be achieved by means of embossed injection moulded parts. According to an embodiment according to the invention, the capsule is produced by injection moulding. The reinforcement is determined by the outside dimensions of the injection mould. If the injection mould has an edge, the edge is reproduced during the injection moulding process as reinforcement of the capsule. If the injection mould is a profile which is rectangular on one side and round on the other side, a flat side of the capsule is formed based on two edges.

In the case of the applicators which are available, the capsule according to the invention is fixed in terms of its position since, due to the edge, the capsule can no longer be turned in the device accepting the capsule. According to the invention, an applicator with an axially rotatable retaining facility is therefore provided for the capsule. In a preferred embodiment, the applicator has two locking positions permitting preferred retention on application of the dental material in the lower or the upper jaw. The applicator can be autoclaved in order to satisfy the hygiene requirements.

### BRIEF DESCRIPTION OF THE SEVERAL VIEWS OF THE DRAWING(S)

FIG. 1 shows a perspective view of the capsule;

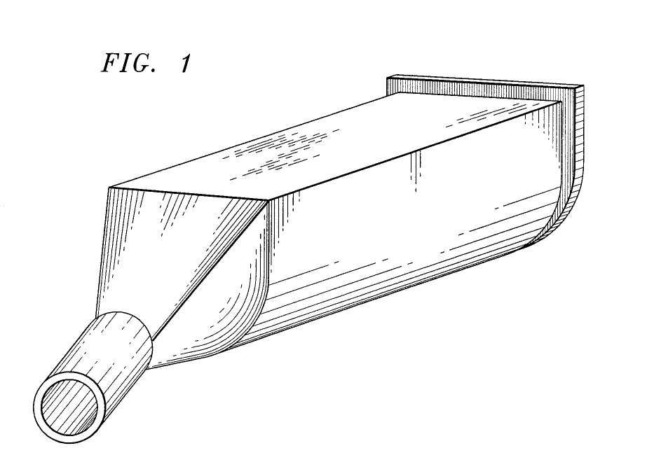

FIG. 2 shows a technical drawing of the sections characterising the capsule.

### DETAILED DESCRIPTION OF THE INVENTION

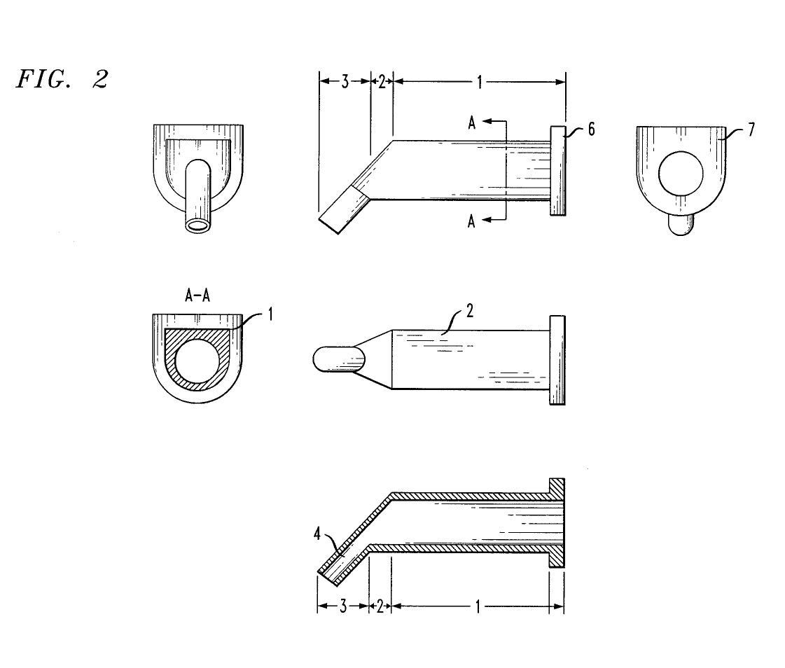

According to FIG. 2, a single-piece plastic capsule consists of three capsule sections 1, 2 and 3. Capsule section 1 exhibits a collar 6 and capsule section 3 exhibits a cylindrical cavity 4. The circumference of the cross-section 7 of capsule section 1 is composed of a semi-circle and square half, the diameter of the semi-circle corresponding to the length of the square such that two corresponding mould parts merge into one another in a flush manner. In comparison with a circular embodiment, the cross-section is enlarged by the edges of the square which, each taken on its own, form approximately the shape of a right-angled triangle. The triangular form is disturbed by the hypotenuse being dented by the circular arc. The edges are rounded and exhibit a right angle corresponding to the square part of the circumference. Consequently, the reinforcement consists of two prisms with a right-angled, approximately triangular base surface. The deviation from the triangle shape corresponds to the replacement of the hypotenuse by the circular arc. The collar 6 skirts the outer contour of capsule section 1.

The adaptation part 2 has an inside diameter with a stump-type course which provides a flush transfer between the cylindrical cavity 4 and the inside diameter of the dispensing nipple 3. In parallel, the outer dimension of capsule section 1 passes over to the outer dimension of the dispensing nipple. This is followed on both sides by two triangular surfaces around which the cuboid external surfaces of the reinforcement continue up to the dispensing nipple in a tapering manner. For the adaptation of the base surface 7 of the cube to the dispensing nipple, the adaptation part is given a trapeze shaped surface which is adapted to the dispensing nipple by way of a round cut-out.

The plastic capsule is produced by the plastic injection moulding process. For this purpose, the material is plasticised in an injection unit using an injection moulding machine and injected into an injection moulding tool. The cavity in the injection moulding tool determines the shape and surface structure of the finished part. For the formation of the inside contour, cores are inserted. All common plastics (PE, PP, POM, PA) can be used. In order to ensure imperviousness to light of the capsules, the plastic is dyed in an appropriate manner before processing.

Following the production of the plastic capsule, it is washed in order to comply with the hygiene requirements.

The plastic capsule thus produced is filled with a highly viscous product (P9), whose viscosity amounts to 8.5-10⁶ MPa. The capsule is closed with caps and, after removal of the caps, used with a discharge force of >1000 N. In contrast to the known capsules, no unserviceable capsules can be observed among the capsules according to the invention.

What is claimed is:

1. The plastic capsule for storage and delivery of dental material comprising
a first capsule section (1), a second capsule section (2), and a third capsule section (3),
a cylindrical cavity (4) in the first capsule section (1), connecting the first and a third capsule section (3) to a second capsule section (2) and the third capsule section (3) being a dispensing nipple angled with respect to the first capsule section (4), wherein the first capsule section (1) comprises a reinforced longitudinal portion and a rounded longitudinal portion and the reinforced longitudinal portion includes an edge on a round tube, the edge forming the reinforcement.

2. The plastic capsule for storage and delivery of dental material comprising
a first capsule section (10), a second capsule section (2), and a third capsule section (3),
a cylindrical cavity (4) disposed in the first capsule section (1) and connecting the first and the third capsule section in a second capsule section (2) and the third capsule section (3) being a dispensing nipple (3) angled with respect to the first capsule section (1), wherein the first capsule section (1) comprises a flat longitudinal side and a longitudinal side formed in a round manner and the flat longitudinal side includes two edges as reinforcements vis-à-vis a round tube.

3. The plastic capsule according to claim 1, wherein the first capsule section (1) includes a collar.

4. The plastic capsule according to claim 1, wherein the first capsule section (1) exhibits at least 20% by weight more material as a result of the reinforcement than a round tube without reinforcement.

5. The plastic capsule according to claim 4, wherein the first capsule section (1) exhibits at least 30% by weight more material as a result of the reinforcement than a round tube without reinforcement.

6. The plastic capsule according to claim 5, wherein the first capsule section (1) exhibits at least 50% by weight more material as a result of the reinforcement than a round tube without reinforcement.

7. The plastic capsule according to claim 1, wherein the reinforcement is arranged on the side facing away from the dispensing nipple (3).

8. The plastic capsule according to claim 1, wherein the cylindrical cavity (4) is formed between an externally round groove and an externally cuboid groove.

9. The plastic capsule according to claim 1, wherein the plastic capsule is formed in one piece.

10. The plastic capsule according to claim 1, wherein is the plastic capsule is inscribed with four lines on a flat side.

11. The plastic capsule according to claim 1, wherein the plastic capsule is suitable of applying a viscous dental compound.

12. The plastic capsule according to claim 1, wherein the plastic capsule has a discharge force of 600 N to 2000 N.

13. A process for injection moulding for the production of a plastic capsule comprising the steps of
providing a first capsule section (1) having a cylindrical cavity (4), a central capsule section (2) connecting the first and a third capsule section and a third capsule section (3) which is a dispensing nipple (3) angled with respect to the first capsule section (1),
wherein the first capsule section (1) is formed as a round tube longitudinally reinforced by an edge.

14. A process for injection moulding for the production of a plastic capsule comprising the steps of p1 providing a first capsule section (1) having a cylindrical cavity (4), a central capsule section connecting the first and a third capsule section and a third capsule section (3) which is a dispensing nipple (3) angled with respect to the first capsule section (1),
wherein the first capsule section (1) is formed in a round manner on a first side and in a flat manner on a second side.

15. An applicator for receiving and discharging dental material from a plastic capsule according to claim 1, wherein the receiving device for the plastic capsule is axially rotatable.

16. The applicator according to claim 15, wherein the device for accepting the plastic capsule exhibits two locking positions.

17. The plastic capsule according to claim 11, wherein the viscous dental compound has a viscosity of 8.5 to 10⁶ MPa.

18. The plastic capsule according to claim 12, wherein the plastic capsule has a discharge force of 600 N to 1000 N.
